(19) United States
(12) Patent Application Publication
(10) Pub. No.: US 2015/0183400 A1
(43) Pub. Date: Jul. 2, 2015

(54) WIPER BLADE AND VEHICLE WIPER DEVICE

(71) Applicant: ASMO CO., LTD., Kosai-shi (JP)

(72) Inventor: Hiroyuki NAKANO, Kosai-shi (JP)

(21) Appl. No.: 14/566,930

(22) Filed: Dec. 11, 2014

(30) Foreign Application Priority Data
Dec. 26, 2013 (JP) 2013-269572

(51) Int. Cl. B60S 1/38

(52) U.S. Cl. CPC B60S 1/38; B60S 2001/3836

(57) ABSTRACT

A wiper blade includes a blade holder and a rubber blade. The rubber blade includes a base portion and a wiping portion. The wiping portion has a cross-sectional shape inclined relative to a drooping direction. At least one of a longitudinally distal portion of the rubber blade and a longitudinally distal portion of the blade holder includes a bent portion located above the wiping portion. The bent portion projects in the direction the wiping portion extends.

### BACKGROUND OF THE INVENTION

The present invention relates to a wiper blade and a vehicle wiper device.

In the prior art, a wiper blade for a vehicle wiper device includes a blade holder and an elongated rubber blade. The rubber blade includes a base portion, which is held by the blade holder, and a wiping portion, which downwardly extends from the base portion and wipes a wiped surface.

A typical rubber blade includes a neck located between the base portion and the wiping portion. When the neck is load-free, the neck extends in a drooping direction that is orthogonal to a lateral direction. During a wiping motion, the neck deforms so that the wiping portion is positioned to incline relative to the moving direction and downwardly extend in a direction opposite to the moving direction. At this position, the wiping portion contacts and wipes the wiped surface during a wiping motion. However, in such a rubber blade, during a reversing motion, the wiping portion is inclines in the opposite direction so that the direction in which the wiping portion extends shifts beyond the drooping direction. This suddenly moves the rubber blade in the vertical direction and produces an impact noise (i.e., reversing noise).

To cope with this problem, for example, Japanese Laid-Open Patent Publication No. 2001-322535 includes a wiping portion that is hollow in the longitudinal direction and has projections projecting out of the two lateral sides of the wiping portion. This structure stops the generation of a reversing noise during a reversing motion.

### SUMMARY OF THE INVENTION

In the rubber blade described above, the rubber blade has high rigidity in the vertical direction and thus resists elastic deformation in the vertical direction. Thus, the rubber blade cannot follow, in a satisfactory manner, a wiped surface that is curved in the longitudinal direction. This adversely affects the wiping performance.

Accordingly in, for example, Japanese Patent Application No. 2012-281580, the applicant of the present application has proposed a rubber blade inclined relative to the drooping direction that is orthogonal to the lateral direction (reciprocation direction). The rubber blade is continuously held in the inclined direction during wiping motions, which include reversing motions. Thus, while maintaining the wiping performance, reversing noise can be reduced. In the rubber blade shown in FIG. 10 of Japanese Patent Application No. 2012-281580, the wiping portion is located at the end of the base portion facing the direction opposite to the starting direction (forward motion direction) when wiping starts, and the wiping portion projects from the end in the direction opposite to the starting direction. Such a rubber blade allows air currents to smoothly flow toward the upper side and the rear of the vehicle when the vehicle is traveling. This reduces, for example, movement resistance during backward motion of the rubber blade.

In the rubber blade described above, rain also moves over the rubber blade during a backward motion of the rubber blade and easily scatters in the direction opposite to the moving direction of the rubber blade. Further, the wiper blade moves faster at its distal portion than at its basal portion. Thus, during a backward motion, the distal portion of the wiper blade has a tendency of scattering rain toward the direction opposite to the moving direction of the wiper blade, that is, toward the wiped surface that has just been wiped or toward the diagonally rear side of the vehicle.

It is an object of the present invention to provide a wiper blade and a vehicle wiper device that minimizes the amount of rain scattered when moved over the longitudinally distal portion of the wiper blade.

To achieve the above object, one aspect of the present invention is a wiper blade including a blade holder and a rubber blade. The blade holder extends in a longitudinal direction and includes a longitudinally distal portion and a longitudinally basal portion. The rubber blade extends in the longitudinal direction and includes a longitudinally distal portion and a longitudinally basal portion. The rubber blade includes a base portion held by the blade holder and a wiping portion downwardly extending from the base portion. The wiping portion is configured to slide in contact with a wiped surface in a lateral direction and wipe the wiped surface. The wiping portion has a cross-sectional shape inclined relative to a drooping direction when the rubber blade is load-free. The cross-sectional shape is a contour of a cross-section of the wiping portion that is orthogonal to the longitudinal direction. The drooping direction is orthogonal to the longitudinal direction and the lateral direction. At least one of the longitudinally distal portion of the rubber blade and the longitudinally distal portion of the blade holder includes a bent portion located above the wiping portion. The bent portion projects in a direction in which the wiping portion extends.

Further aspect of the present invention is a wiper including a blade holder extending along a longitudinal direction, a blade extending along a longitudinal direction, and a bent portion. The holder has a longitudinally distal portion and a longitudinally basal portion. The blade has a longitudinally distal portion and a longitudinally basal portion. The blade rubber includes a base portion retained by the blade holder and a wiping portion extending outwardly from the base portion to an outside the blade holder. The wiping portion is operative to contact and wipe a wiped surface along a lateral direction. The wiping portion has a cross-sectional shape having an oblique angle with respect to a direction of travel of the blade when the blade is load-free. The bent portion is arranged proximate to the longitudinal distal end of the blade holder.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic plan view of a vehicle wiper according to one embodiment of the present invention;

FIG. 2 is a cross-sectional view taken along line 2-2 in FIG. 1;

FIG. 3 is a side view of the wiper blade shown in FIG. 1;

FIG. 4 is a side view of a wiper blade in a further example;

FIG. 5 is a side view of a wiper blade in a further example;

FIG. 6 is a side view of a wiper blade in a further example;

FIG. 7 is a schematic plane view of a vehicle wiper in a further example; and

FIG. 8 is a cross-sectional view taken along line 8-8 in FIG. 7.

### DETAILED DESCRIPTION OF THE INVENTION

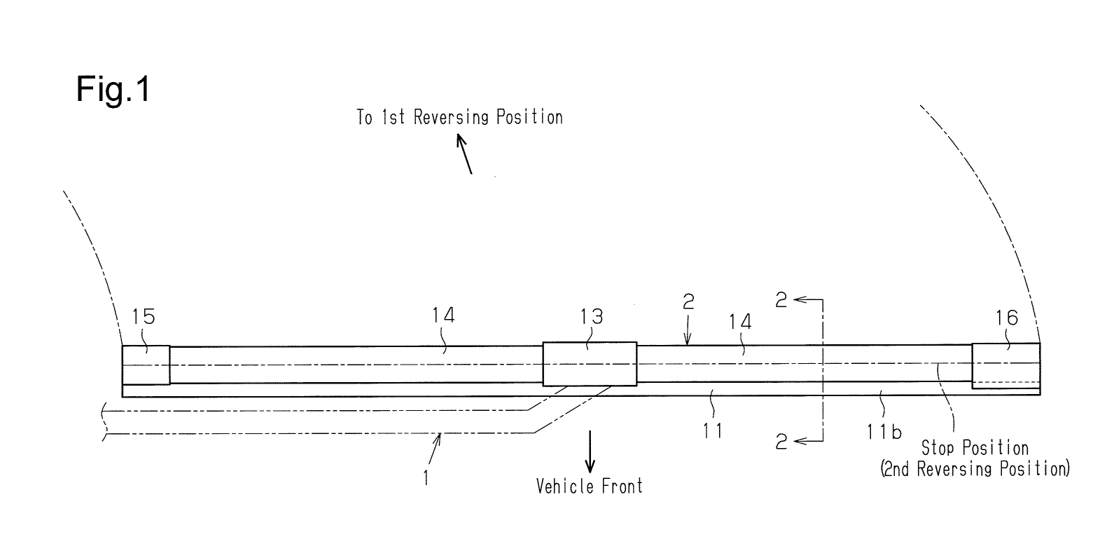

One embodiment of a vehicle wiper device will now be described with reference to FIGS. 1 to 3.

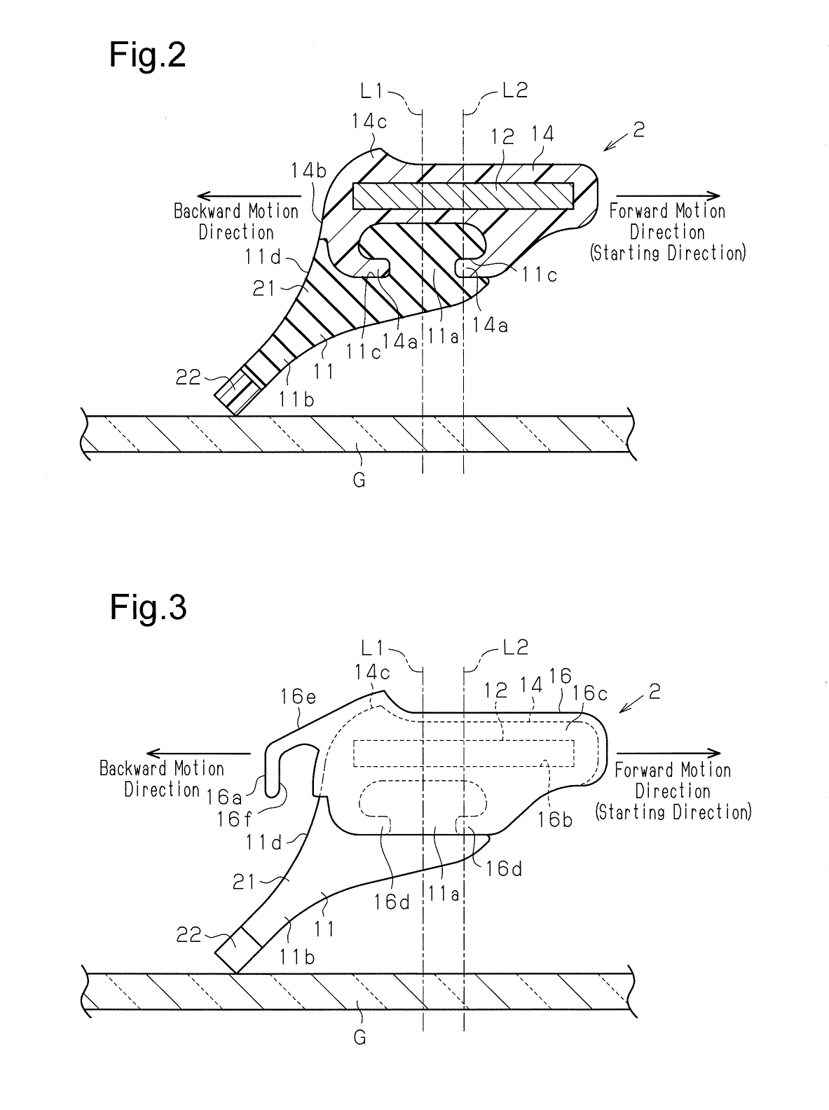

As shown in FIG. 1, a vehicle wiper for a vehicle wiper device includes a wiper arm 1 and a wiper blade 2, which is coupled to a distal portion of the wiper arm 1. The vehicle wiper device of the present embodiment wipes off fluid, such as rain, from a windshield G (refer to FIG. 2), which serves as a wiped surface of a vehicle. A stop position of the vehicle wiper device is set at the lower end of the windshield G. At the stop position, the vehicle wiper device generally extends along the lower side of the windshield G.

The wiper arm 1 includes a basal portion fixed to a pivot shaft (not shown). A wiper motor (not shown) transmits drive force to the pivot shaft to rotate the pivot shaft back and forth by a predetermined angle. An urging mechanism (not shown) urges the distal portion of the wiper arm 1 toward the windshield G. The wiper blade 2 is pivotally coupled to the distal portion of the wiper arm 1.

As shown in FIGS. 1 to 3, the wiper blade 2 includes an elongated rubber blade 11, a plate spring backing 12 (refer to FIG. 2), and a central holder 13. The rubber blade 11 includes a longitudinally distal portion and a longitudinally basal portion. The rubber blade 11 wipes the windshield G. The backing 12 applies rigidity and elasticity to the rubber blade 11. The central holder 13 holds a longitudinally central part of a base portion 11a of the rubber blade 11 and a longitudinally central part of the backing 12. Further, at the base portion 11a of the rubber blade 11, two cases 14 respectively extend in the longitudinal direction from opposite sides of the central holder 13. Further, the two longitudinal ends of the base portion 11a of the rubber blade 11 are held by the blade caps 15 and 16. The two sides of the backing 12 projecting from the central holder 13 are accommodated in the cases 14. Thus, the backing 12 supports the cases 14. Additionally, the blade caps 15 and 16 are coupled to the two longitudinal ends of the backing 12. In the present embodiment, a blade holder includes the central holder 13, the cases 14, and the blade caps 15 and 16. The backing 12 has substantially the same length as the rubber blade 11. The backing 12 is laid out so that the plane of the backing 12 extends substantially parallel to a lateral direction (reciprocation direction) that extends along the windshield G. The backing 12 is curved in the longitudinal direction in conformance with the curved surface of the windshield G. Thus, the backing 12 urges the wiper blade 2 toward the curved windshield G. As a result, a lower portion of the rubber blade 11 defining a wiping portion 11b is pressed against the windshield G to contact the windshield G in a satisfactory manner. The cases 14 are formed from a soft resin material so as not to obstruct the effect of the backing 12.

The wiping portion 11b of the rubber blade 11 is inclined relative to the drooping direction (downward direction as viewed in FIGS. 2 and 3) that is orthogonal to the lateral direction (sideward direction as viewed in FIGS. 2 and 3).

In detail, the lower portion of each case 14 in this example as viewed in FIG. 2 includes two holding portions 14a projecting toward the inner side in the lateral direction. In this example, the center L1 of the two holding portions 14a in the lateral direction is shifted from the center L2 of the backing 12 in the lateral direction toward the side opposite to the starting direction when wiping starts.

The rubber blade 11 includes the base portion 11a, which is held by the holding portions 14a, and the wiping portion 11b, which extends toward the lower side from the base portion 11a (toward the windshield G when mounted on a vehicle). The wiping portion 11b slides in the lateral direction (sideward direction as viewed in FIG. 2) and wipes the windshield G.

The two lateral sides of the base portion 11a each include a holding groove 11c extending in the longitudinal direction. The distal end of each holding portion 14a is fitted into the corresponding holding groove 11c. This holds the base portion 11a with the holding portions 14a.

The wiping portion 11b has a cross-sectional shape that inclines relative to the drooping direction (downward direction as viewed in FIGS. 2 and 3) when the rubber blade 11 is load-free. The cross-sectional shape refers to the contour of the cross-section of the wiping portion 11b that is orthogonal to the longitudinal direction. The drooping direction is orthogonal to the longitudinal direction and the lateral direction (direction substantially extending along the windshield G, lateral direction as viewed in FIG. 2). The wiping portion 11b of this example projects from the end of the base portion 11a facing the direction opposite to the starting direction when wiping starts, and the wiping portion 11b extends diagonally relative to the drooping direction. In other words, the wiping portion 11b extends in an extension direction from the base portion 11a toward the windshield G. The extension direction is inclined relative to the drooping direction.

The wiping portion 11b extends outwardly from the base portion 11a in the lateral direction. When the rubber blade 11 is load-free, the wiping portion 11b has a cross-sectional shape that is inclined relative to the moving direction of the rubber blade 11.

The wiping portion 11b of this example includes a resin member 22 located at the lowest end of the wiping portion 11b. More specifically, the resin member 22 is coupled to the wiping portion 11b. The resin member 22 is formed from a resin material that is harder than an elastic member 21, which is the portion of the rubber blade 11 near the base portion 11a. Further, the resin member 22 and the elastic member 21 are formed from compatible resin materials, that is, resin materials of similar components. The resin material of the resin member 22 has a low coefficient of friction. Compatibility refers to a characteristic in which two or more affinity substances form a solution or a mixture.

In detail, the base portion 11a is formed by the elastic member 21. The wiping portion 11b excluding the lowest end (resin member 22) is formed by the elastic member 21. The elastic member 21 is formed from a rubber elastic material, which is, for example, a thermoplastic polyester elastomer (TPEE). That is, the rubber blade 11 is formed from a softer rubber elastic material than the cases 4.

The resin member 22 is formed from, for example, polyethylene terephthalate (PET), which is an ester. Thus, the resin member 22 is harder than the elastic member 21. That is, when applying a constant load, the deformation amount of the resin member 22 is smaller than the deformation amount of the elastic member 21. The resin member 22 and the elastic member 21 are formed from compatible materials of similar components.

The base portion 11a and each case 14 of this example respectively include sloped surfaces 11d and 14b defined by end surfaces facing the direction opposite to the starting direction when wiping starts. The sloped surfaces 11d and 14b are inclined relative to the starting direction and extend toward the upper side (direction opposite to the drooping direction, upper direction as viewed in FIG. 2). The sloped surfaces 11d and 14b extend continuously and are free from steps. The sloped surfaces 11d and 14b are formed by the entire end surfaces of the rubber blade 11 and each case 14 facing the direction opposite to the starting direction when wiping starts. In the rubber blade 11, the sloped surface 11d is continuous with the base portion 11a and the wiping portion 11b. The “sloped surfaces 11d and 14b extend continuously and are free from steps” means that the sloped surfaces 11d and 14b are free from portions that are not inclined to the starting direction and extend toward the upper side as viewed in FIG. 2. The step-free sloped surfaces 11d and 14b do not have to be flat. In this example, the sloped surfaces 11d and 14b are curved.

The upper portion of each case 14 facing the direction opposite to the starting direction includes a projection 14c that increases the sloped surface 14b in area.

The blade caps 15 and 16 are fixed to the two ends of the backing 12. The blade caps 15 and 16 restrict movement of the cases 14 relative to the backing 12 in the longitudinal direction.

As shown in FIG. 3, the wiper blade 2 includes a longitudinally distal portion where the blade cap 16 is located. The blade cap 16 includes a bent portion 16a, which is located above the wiping portion 11b. The bent portion 16a is arranged on at least a portion of the blade holder located closer to the longitudinally distal side than the central holder 13. In other words, the bent portion 16a is located proximate to the longitudinally distal end of the blade holder. The bent portion 16a is located on the blade cap 16 (rubber blade) near the upper end in the upper surface of the inclined wiping portion 11b (surface opposite to surface facing windshield G). The bent portion 16a projects in the direction the wiping portion 11b extends, that is, overhangs in the direction opposite to the starting direction (left side as viewed in FIG. 3).

In detail, the blade cap 16 includes a cap body 16c that includes a fastening hole 16b. The backing 12, which projects from the case 14 in the longitudinal direction (toward the upper side of the drawing plane of FIG. 3) is fitted into the fastening hole 16b. An end of the backing 12 is fitted into the fastening hole 16b so that the blade cap 16 is fixed to the backing 12 to be immovable in the longitudinal direction. Further, the blade cap 16 includes two holding portions 16d extending from the cap body 16c toward the lower side. The two holding portions 16d hold the longitudinal end of the base portion 11a of the rubber blade 11 projecting from the corresponding case 14 in the longitudinal direction. Further, the blade cap 16 includes the bent portion 16a, which projects from a portion of the cap body 16c facing the direction opposite to the starting direction (left side as viewed in FIG. 3). The upper surface of the bent portion 16a in the present embodiment defines a sloped cap surface 16e. The sloped cap surface 16e extends diagonally downward and toward the side opposite to the starting direction (left side as viewed in FIG. 3) from the location of the cap body 16c corresponding to the projection 14c of the case 14. The sloped cap surface 16e allows air currents to smoothly flow toward the upper side and the rear of the vehicle when the vehicle is traveling. Further, the sloped cap surface 16e converts the force of the air currents to force urging the wiper blade 2 toward the windshield G. Additionally, the bent portion 16a of the present embodiment includes a recess 16f that opens toward the lower side. The blade cap 16 located at a longitudinally basal portion of the wiper blade 2 lacks a bent portion.

The operation of the vehicle wiper device will now be described.

When the wiper blade 2 is located at the stop position (lower end of windshield G), the wiper motor is activated to start a forward motion. This further inclines the wiping portion 11b relative to the drooping direction and slightly lowers the base portion 11a. Under this situation, the distal end (resin member 22) of the wiping portion 11b slides in contact with the windshield G and wipes the windshield G.

When the wiper blade 2 reaches a first reversing position, the wiper blade 2 is reversed to start a backward motion. This slightly lifts the wiping portion 11b so that the inclination of the wiping portion 11b approaches the drooping direction. Under this situation, the distal end (resin member 22) of the wiping portion 11b slides in contact with the windshield G and wipes the windshield G.

The above embodiment has the advantages described below.

(1) When the rubber blade 11 is load-free, the wiping portion 11b has a cross-sectional shape that is inclined relative to the drooping direction. The drooping direction is orthogonal to the longitudinal direction and the lateral direction. Further, the wiping portion 11b of the present embodiment is formed so that the inclination direction of the wiping portion 11b does not shift beyond the drooping direction during wiping motions including reversing motions. That is, the wiping portion 11b is held at one side of the drooping direction so that the inclination direction of the wiping portion 11b is not reversed toward the opposite side during forward and backward motions.

Thus, during a reversing motion, the wiping portion 11b does not move beyond the drooping direction and does not incline toward the opposite side. This prevents the wiping portion 11b from suddenly moving in the vertical direction and thus reduces the reversing noise that would be produced during a reversing motion.

Moreover, the wiping portion 11b is inclined relative to the drooping direction. Thus, the wiping portion 11b has low rigidity in the vertical direction. This allows for easy elastic deformation in the vertical direction (i.e., curved deformation in the longitudinal direction). Thus, the wiping portion 11b is able to follow the curved windshield G in a satisfactory manner and allows the wiping performance to be maintained. Further, the wiping portion 11b is inclined relative to the drooping direction as a descending slope directed toward the front of the vehicle. Thus, when the wiper blade 2 is undergoing a backward motion from the first reversing position to the second reversing portion, the inclined wiping portion 11b receives air currents that act as a pushing force applied to the wiper blade 2 and limit lifting of the wiper blade 2.

The longitudinally distal portion of the wiper blade 2 includes the bent portion 16a, which is located above the wiping portion 11b. The bent portion 16a projects from the wiper blade 2 so as to overhang from the wiper blade in the direction in which the wiping portion 11b extends.

The bent portion 16a is operative to impinge the rain (fluid) wiped off the windshield G by the rubber blade 11. The bent portion 16a is arranged to extend outwardly relative to the blade cap 16 (blade holder) such that a portion of the bent portion 16a overlaps a portion of the wiping portion 11b extending outwardly from the base portion 11a. In operation, the rubber blade 11 is arranged between the bent portion 16a and the windshield G. The bent portion 16a partially defines an impingement surface facing the wiping portion 11b.

This minimizes the amount of rain scattered when moved over the longitudinally distal portion of the wiper blade 2. For example, when the wiper blade 2 undergoes a backward motion and moves from the first reversing portion to the second reversing position, the wiper blade 2 is inclined as a descending slope in the moving direction of the wiper blade 2. The rain that is wiped off and collected ascends along the sloped surface 11d of the wiping portion 11b and tends to scatter on the windshield G that has been wiped. However, the bent portion 16a returns the rain in the backward motion direction of the wiper blade 2, and the rain cannot ascend the sloped surface 11d. This minimizes the amount of rain scattered in the direction opposite to the moving direction of the wiper blade 2, that is, toward the windshield G that has just been wiped or toward the diagonally rear side of the vehicle.

(2) The blade cap 16 is fixed to the distal portion of the backing 12. The blade cap 16 is configured to restrict movement of the case 14 relative to the backing 12 in the longitudinal direction. The bent portion 16a is located on the blade cap 16. Thus, there is no need for the bent portion to be a separate member.

(3) The bent portion 16a includes the recess 16f, which opens toward the lower side.

Thus, the bent portion 16a partially defines a cavity (recess 16f) with an opening facing the wiping portion 11b. The cavity defines a channel arranged along the longitudinal direction of the rubber blade 11. The cavity is operative to limit a flow of rain (fluid) wiped from the windshield G by the wiping portion 11b. The limit of the flow of the rain wiped from the windshield G reduces an amount of fluid flowing from a first area to a second area of the windshield G. The wiper blade 2 is disposed between the first area and the second area. More specifically, the first area of the windshield G is located in the backward motion direction from the wiper blade 2 during a backward motion. The second area of the windshield G is located in the forward motion direction from the wiper blade 2 during a backward motion.

In comparison to a structure that does not include the recess, the amount of rain scattered from the first area to the second area when moved over the longitudinally distal portion of the wiper blade 2 can be minimized.

(4) The wiping portion 11b projects from the end of the base portion 11a facing the direction opposite to the starting direction. That is, the wiping portion 11b is located on a part of the base portion 11a facing the backward motion direction and projects from this part in the backward motion direction. The stop position is set at the lower end of the windshield G. At the stop position, the vehicle wiper device generally extends along the lower side of the windshield G. The rubber blade 11 and the blade holder are configured to pivot in the forward motion direction, which is directed from the stop position to the first reversing position, and the backward motion direction, which is directed from the first reversing position to the second reversing position (in the present example, same as the stop position). In this structure, air currents can smoothly flow toward the upper side and the rear of the vehicle when the vehicle is traveling, and, for example, movement resistance can be reduced during a backward motion of the rubber blade. Further, the wiping portion 11b receives air currents that act as a pushing force applied to the wiper blade 2 and limit lifting of the wiper blade 2. The bent portion 16a is arranged on the blade cap 16 at a location facing toward the backward motion direction and projects from this location toward the backward motion direction. This structure effectively minimizes the amount of rain moved together with air currents beyond the wiper blade 2 and scattered in the direction opposite to the moving direction of the wiper blade 2.

It should be apparent to those skilled in the art that the present invention may be embodied in many other specific forms without departing from the spirit or scope of the invention. Particularly, it should be understood that the present invention may be embodied in the following forms.

As long as the bent portion 16a of the above embodiment projects in the direction the wiping portion 11b projects, the shape of the bent portion 16a may be changed.

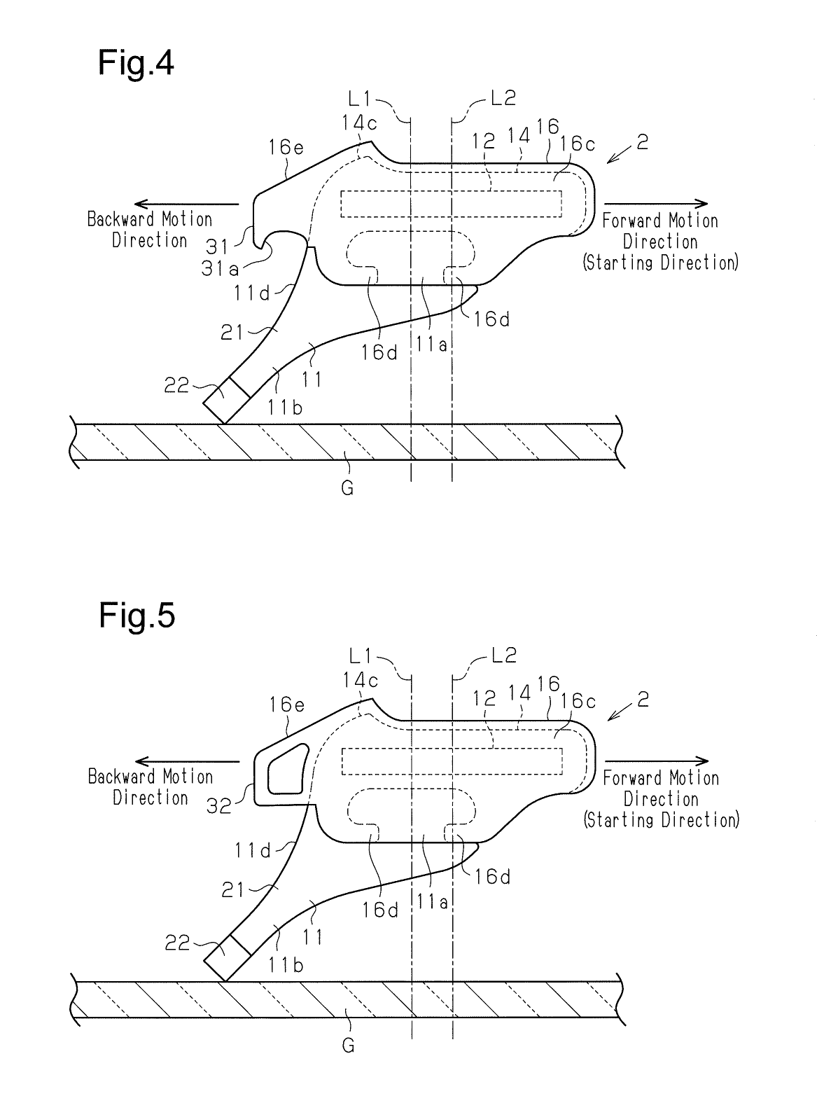

For example, as shown in FIG. 4, the bent portion 16a may be changed to a bent portion 31 including a recess 31a that is slightly hollowed and shallower than the recess 16f of the above embodiment.

For example, as shown in FIG. 5, the bent portion 16a may be changed to a bent portion 32 that lacks the recess 16f of the above embodiment and has a lower surface that is flat and generally parallel to the lateral direction.

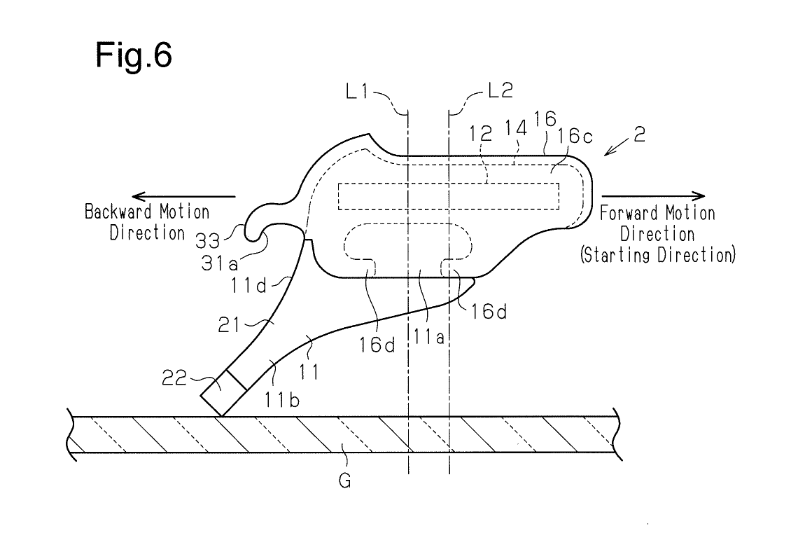

For example, as shown in FIG. 6, the bent portion 16a may be a changed to a bent portion 33 that lacks the sloped cap surface 16e. The bent portion 33 of this example includes the recess 31a that is slightly hollowed.

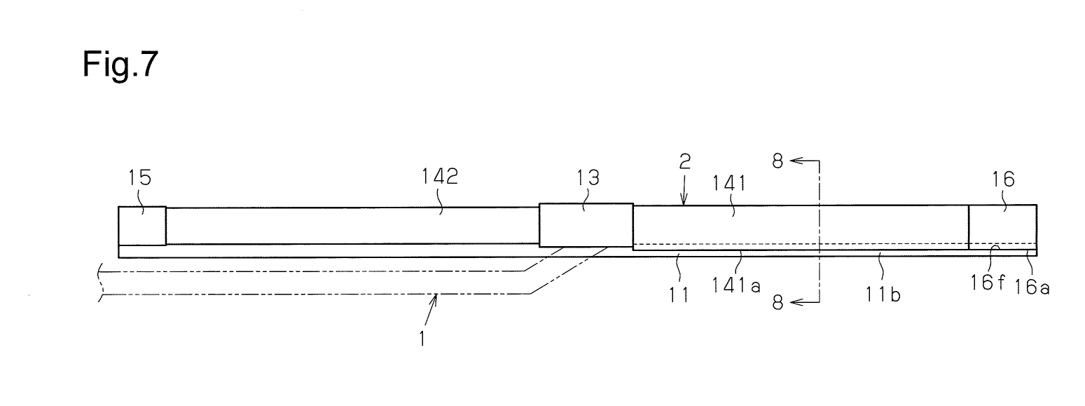

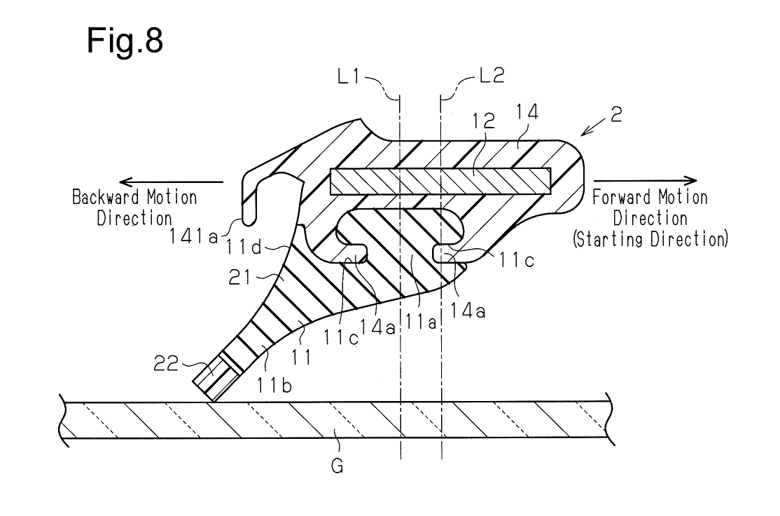

In the above embodiment, the blade cap 16 includes the bent portion 16a. In addition to the bent portion 16a, the blade holder may include a bent portion 141a on the first case 141. For example, as shown in FIGS. 7 and 8, the cases 14 may include a first case 141, which is located toward the longitudinally distal end of the blade holder from the central holder 13, and a second case 142, which is located toward the longitudinally basal end of the blade holder from the central holder 13. The bent portion 141a is located on the first case 141 and extends in the longitudinal direction. The bent portion 141a extends between the central holder 13 and the blade cap 16. In the same manner as the above embodiment, this structure minimizes the amount of rain scattered toward the windshield G that has just been wiped or toward the diagonally rear side of the vehicle.

In the above embodiment, the bent portion 16a is formed on the blade cap 16 but only needs to be arranged on a similar component. For example, a bent portion may be formed on a component that differs from the blade cap.

The longitudinally distal portion of the rubber blade 11 may include a bent portion located above the wiping portion 11b.

The longitudinally distal portion of the rubber blade 11 and the longitudinally distal portion of the blade holder may both include a bent portion located above the wiping portion 11b.

In the above embodiment, the blade holder includes the central holder 13, the case 14, and the blade caps 15 and 16. The present invention may be embodied in a different blade holder that holds a rubber blade. For example, instead of the blade holder, the present invention may be embodied in a lever assembly that includes a primary lever, a secondary lever, and a yoke and holds a rubber blade with a yoke. In this case, for example, a bent portion may be arranged on the rubber blade above the wiping portion.

In the above embodiment, the present invention is embodied in a vehicle wiper device of which the wiped surface is the windshield G. However, the present invention may be embodied in a vehicle wiper device of which the wiped surface is a rear window.

The present examples and embodiments are to be considered as illustrative and not restrictive, and the invention is not to be limited to the details given herein, but may be modified within the scope and equivalence of the appended claims.

1. A wiper blade comprising:
a blade holder that extends in a longitudinal direction and includes a longitudinally distal portion and a longitudinally basal portion; and
a rubber blade that extends in the longitudinal direction and includes a longitudinally distal portion and a longitudinally basal portion, wherein the rubber blade includes a base portion held by the blade holder and a wiping portion downwardly extending from the base portion, the wiping portion is configured to slide in contact with a wiped surface in a lateral direction and wipe the wiped surface, wherein
the wiping portion has a cross-sectional shape inclined relative to a drooping direction when the rubber blade is load-free,
the cross-sectional shape is a contour of a cross-section of the wiping portion that is orthogonal to the longitudinal direction,
the drooping direction is orthogonal to the longitudinal direction and the lateral direction,
at least one of the longitudinally distal portion of the rubber blade and the longitudinally distal portion of the blade holder includes a bent portion located above the wiping portion, and
the bent portion projects in a direction in which the wiping portion extends.

2. The wiper blade according to claim 1, wherein the bent portion is located on at least one of the rubber blade and the blade holder near an upper end of an upper surface of the wiping portion that is inclined.

3. The wiper blade according to claim 1, wherein
the blade holder includes a central holder that is coupled to a wiper arm, and
the bent portion is arranged on at least one of at least a portion of the blade holder located closer to a longitudinally distal end of the blade holder than the central holder and at least a portion of the rubber blade located closer to a longitudinally distal end of the rubber blade than the central holder.

4. The wiper blade according to claim 1, further comprising a backing, wherein
the blade holder includes a case that holds the backing and holds substantially the entire base portion in the longitudinal direction,
the case is formed from a soft resin material, and
the rubber blade is formed from a softer rubber elastic material than the case.

5. The wiper blade according to claim 1, further comprising a backing, wherein
the blade holder includes a central holder coupled to a wiper arm and a case that holds the backing and substantially the entire base portion in the longitudinal direction;
the case includes a first case, which is located closer to a longitudinally distal end of the blade holder than the central holder, and a second case, which is located closer to a longitudinally basal end of the blade holder than the central holder; and
the bent portion is arranged on the first case and extends in the longitudinal direction.

6. The wiper blade according to claim 4, wherein
the blade holder further includes a blade cap fixed to a distal portion of the backing,
the blade cap is configured to restrict movement of the cap relative to the backing in the longitudinal direction, and
the bent portion is arranged on the blade cap.

7. The wiper blade according to claim 5, wherein
the blade holder further includes a blade cap fixed to a distal portion of the backing,
the blade cap is configured to restrict movement of the case relative to the backing in the longitudinal direction, and
the bent portion is arranged on the blade cap.

8. The wiper blade according to claim 1, wherein the bent portion includes a recess that opens toward a lower side.

9. The wiper blade according to claim 1, wherein
the rubber blade and the blade holder are configured to pivot in a forward motion direction extending from a stop position to a reversing portion and a backward motion direction extending from the reversing portion to the stop position;
the wiping portion is arranged on a part of the base portion facing the backward motion direction, and the wiping portion projects from the part of the base portion in the backward motion direction; and
the bent portion is arranged on a part of the blade holder facing the backward motion direction, and the bent portion projects from the part of the blade holder in the backward motion direction.

10. The wiper blade according to claim 1, wherein
the drooping direction is orthogonal to the wiped surface,
the wiping portion extends in an extension direction from the base portion toward the wiped surface, and
the extension direction is inclined relative to the drooping direction.

11. The wiper blade according to claim 1, wherein the wiped surface is a windshield of a vehicle.

12. A wiper comprising:
a blade holder extending along a longitudinal direction, the holder having a longitudinally distal portion and a longitudinally basal portion;
a blade extending along a longitudinal direction, the blade having a longitudinally distal portion and a longitudinally basal portion, the blade rubber includes a base portion retained by the blade holder and a wiping portion extending outwardly from the base portion to an outside the blade holder, wherein the wiping portion is operative to contact and wipe a wiped surface along a lateral direction, the wiping portion has a cross-sectional shape having an oblique angle with respect to a direction of travel of the blade when the blade is load-free; and
a bent portion arranged proximate to the longitudinal distal end of the blade holder.

13. The wiper of claim 12, wherein the bent portion is operative to impinge fluid wiped from the wiped surface by the blade.

14. The wiper of claim 12, wherein the bent portion is arranged to extend outwardly relative to the blade holder such that a portion of the bent portion overlaps a portion of the wiping portion extending outwardly from the base portion.

15. The wiper of claim 12, wherein in operation, the blade is arranged between the bent portion and the wiped surface.

16. The wiper of claim 12, wherein the bent portion partially defines a cavity with an opening facing the wiping portion.

17. The wiper of claim 16, wherein the cavity defines a channel arranged along the longitudinal direction of the blade.

18. The wiper of claim 16, wherein the cavity is operative to limit a flow of fluid wiped from the wiped surface by the wiping portion.

19. The wiper of claim 18, wherein the limit of the flow of the fluid wiped from the wiped surface reduces an amount of fluid flowing from a first area to a second area of the wiped surface, wherein the wiper is disposed between the first area and the second area.

20. The wiper of claim 12, wherein the bent portion partially defines an impingement surface facing the wiping portion.
